(19) United States
(12) Patent Application Publication
(10) Pub. No.: US 2023/0202888 A1
(43) Pub. Date: Jun. 29, 2023

(54) MANAGEMENT METHOD FOR WATER TREATMENT DEVICE, REPLACEMENT METHOD FOR WATER TREATMENT MEMBER, AND LIFE EXPECTANCY ESTIMATION METHOD FOR WATER TREATMENT MEMBER

(71) Applicant: KUBOTA CORPORATION, Osaka-shi, Osak (JP)

(72) Inventors: Soichiro YATSUGI, Amagasaki-shi (JP); Shinya NAGAE, Tokyo (JP)

(73) Assignee: KUBOTA CORPORATION, Osaka-shi, Osaka (JP)

(21) Appl. No.: 17/925,996

(22) PCT Filed: May 25, 2021
(86) PCT No.: PCT/JP2021/019751

§ 371 Date: Nov. 17, 2022

(30) Foreign Application Priority Data
Jun. 1, 2020 (JP) 2020-095650

(51) Int. Cl. C02F 3/00; C02F 1/44; C02F 3/12

(52) U.S. Cl. CPC C02F 3/006; C02F 1/44; C02F 3/1273; C02F 2209/445; C02F 2303/14; C02F 2209/006

(57) ABSTRACT

A management method for a water treatment device that serves as a management method for water treatment equipment provided with a plurality of water treatment devices on each of which a plurality of water treatment members is mounted includes performing life expectancy estimation processing to estimate a life expectancy of each water treatment member based on history information of each water treatment member, the history information being updatable as needed, and performing external life expectancy homogenization processing to replace corresponding water treatment members with each other among a plurality of water treatment devices at a predetermined period so that other water treatment members each having a life expectancy within a predetermined range with respect to the life expectancy of each water treatment member estimated in the life expectancy estimation processing are mounted in an identical water treatment device.

### TECHNICAL FIELD

The present invention relates to a management method for a water treatment device, a replacement method for a water treatment member, and a life expectancy estimation method for the water treatment member.

### BACKGROUND ART

A plurality of replaceable water treatment members is mounted on a water treatment device. Each water treatment member requires various kinds of maintenance, such as cleaning when it decreases in performance and replacement when it is broken or approaches the end of its lifetime.

Examples of such a water treatment device include, in a field of water treatment such as purification treatment on organic waste water, a membrane unit on which a plurality of membrane modules for solid-liquid separation is mounted to extract treated water from waste water subjected to biological treatment, and an activated carbon unit on which a plurality of activated carbon cartridges is mounted to perform advance treatment on the treated water extracted by the membrane unit. Each of the membrane unit and the activated carbon unit serves as the water treatment device, and each of the membrane module and the activated carbon cartridge serves as the water treatment member.

Patent Literature 1 discloses, as an example of the membrane unit, a membrane separation device that includes a plurality of membrane modules each including a plurality of membrane elements, a frame body accommodating the membrane modules by stacking the membrane modules in multiple stages, a closing member closing an end portion of the frame body so as to prevent the membrane modules accommodated in the frame body from being released, and an elastic member disposed in the frame body so that the elastic member is elastically deformed in a vertical direction in a state where the end portion of the frame body is closed.

There is a certain variation in lifetime of the water treatment member such as the membrane module depending on a manufacturing lot, and there is also a difference in lifetime depending on a usage state and a usage environment even in an identical manufacturing lot. Hence, in a case where a failure such as a breakage occurs in one of a plurality of water treatment members mounted on the water treatment device such as the membrane unit, the whole of the water treatment device is stopped to operate, and a failed water treatment member is replaced.

### CITATION LIST

### Patent Literature

Patent Literature 1: Japanese Unexamined Patent Application Publication No. 2012-148229

### SUMMARY OF INVENTION

### Technical Problem

As described above, if an individual water treatment member is replaced with a new water treatment member every time a failure occurs, a relatively old water treatment member and a new water treatment member exist in an identical water treatment device in a mixed state. Thus, there is a possibility that an operating rate of the water treatment device gradually decreases due to the occurrence of the failure, and consequently, there is a possibility that frequency of replacement work for a water treatment member increases and a burden on an operator also increases.

Generally, there is a certain difference in lifetime of the water treatment member depending on a manufacturing lot and there is also a difference in lifetime depending on a usage state and a usage environment thereafter even in an identical manufacturing lot.

To address this, there is a demand for extending a lifetime of each water treatment member by an operator grasping a history of an individual water treatment member and adjusting a usage state and a usage environment, and preventing a decrease in operating rate of a water treatment device.

However, in large-scale water treatment equipment using multitudes of water treatment devices, it is extremely difficult for the operator to individually manage histories of a plurality of water treatment members that is mounted on an individual water treatment device and adjust a usage state and an environment state.

The present invention has been made in consideration of the above-mentioned issues, and is directed to provision of a management method for a water treatment device to manage the water treatment device so as to extend a lifetime of an individual water treatment member based on history information of the water treatment member, and a replacement method for the water treatment member, and a life expectancy estimation method for the water treatment member.

### Solution to Problem

In order to achieve the above-mentioned objective, as a first feature configuration of a management method for a water treatment device according to the present invention, a management method for water treatment equipment provided with a plurality of water treatment devices on each of which a plurality of water treatment members is mounted includes performing life expectancy estimation processing to estimate a life expectancy of each water treatment member based on history information of each water treatment member, the history information being updatable as needed, and performing external life expectancy homogenization processing to replace corresponding water treatment members with each other among a plurality of water treatment devices at a predetermined period so that other water treatment members each having a life expectancy within a predetermined range with respect to the life expectancy of each water treatment member estimated in the life expectancy estimation processing are mounted in an identical water treatment device.

The history information of the water treatment member mounted on the water treatment device is updated with an operation of the water treatment device, and the life expectancy estimation processing to estimate the life expectancy of each water treatment member is performed based on the history information. Based on the estimated life expectancy of each water treatment member, the external life expectancy estimation processing to remove water treatment members each having a life expectancy within the predetermined range from a life expectancy of a water treatment member mounted on a water treatment device, that is, an external water treatment device, and mount the water treatment members having similar life expectancies on an identical water treatment device is performed at a predetermined period, whereby it is possible to reconstruct water treatment devices into a water treatment device on which a plurality of water treatment members each having a relatively short life expectancy is mounted, a water treatment device on which a plurality of water treatment members each having a long life expectancy is mounted, and the like. As a result, even if a failure occurs in the water treatment device on which the plurality of water treatment members each having the relatively short life expectancy is mounted, it is possible to reduce frequency of occurrence of the failure in the other water treatment devices, and increase an operating rate of the water treatment devices as a whole.

As a second feature configuration of the management method for the water treatment device according to the present invention, a management method for water treatment equipment provided with a water treatment device on which a plurality of water treatment members is mounted includes performing life expectancy estimation processing to estimate a life expectancy of each water treatment member based on history information of each water treatment member, the history information being updatable as needed, and performing, based on the life expectancy of each water treatment member estimated in the life expectancy estimation processing, internal life expectancy homogenization processing to life expectancy homogenization processing to, at a predetermined period, mount a water treatment member having a relatively long life expectancy at a high-processing load position in an identical water treatment device and mount a water treatment member having a relatively short life expectancy at a low-processing load position in the identical water treatment device.

The history information of the water treatment member mounted on the water treatment device is updated with an operation of the water treatment device, and the life expectancy estimation processing to estimate the life expectancy of each water treatment member is performed based on the history information. Based on the estimated life expectancy of each water treatment member, the internal life expectancy homogenization processing to mount the water treatment member having the relatively long life expectancy at the high-processing load position and mount the water treatment member having the relatively short life expectancy at the low-processing load position in the identical water treatment device is performed at the predetermined period, whereby it is possible to extend the life expectancy of the water treatment member having the short life expectancy, avoid occurrence of a failure as much as possible, and increase an operating rate of the water treatment device.

As a third feature configuration of the management method for the water treatment device according to the present invention, the history information includes a manufacturing history and a usage history that are managed for each water treatment member, and the life expectancy estimation processing is to perform learning processing on previously acquired history information of a plurality of water treatment members until occurrence of a failure to generate a life expectancy estimation model representing a relationship between individual history information and a life expectancy, and apply history information of an individual water treatment member to the life expectancy estimation model to estimate the life expectancy.

The learning processing is performed on history information of a plurality of water treatment members in each of which a failure occurs, whereby a relationship between a lifetime from a manufacturing period to the occurrence of the failure and history information can be obtained, and the life expectancy estimation model indicating how much a life expectancy is left is generated with respect to freely-selected history information based on the relationship. The inclusion of the manufacturing history as the history information enables incorporation of the life expectancy depending on the manufacturing period into the life expectancy estimation model. The inclusion of the usage history enables incorporation of the life expectancy depending on a usage state, such as accumulated operating time and the number of cleanings, into the life expectancy estimation model. The history information of a water treatment member as an estimation target is applied to the generated life expectancy estimation model, whereby the life expectancy of the water treatment member as the estimation target is estimated.

In addition to any one of the first to third feature configurations, the management method for the water treatment device according to the present invention has a fourth feature configuration that the water treatment member is a membrane module, and the water treatment device is a membrane unit on which the membrane module is mounted.

When the water treatment member is the membrane module and the water treatment device is the membrane unit on which the membrane module is mounted, the life expectancy until the occurrence of the failure of the membrane module can be properly estimated.

As a first feature configuration of a replacement method for a water treatment member according to the present invention, a replacement method for a water treatment member that is mounted on each of a plurality of water treatment devices includes performing life expectancy estimation processing to estimate a life expectancy of each water treatment member based on history information of each water treatment member, the history information being updatable as needed, and performing, when need for replacement of a water treatment member in a first water treatment device arises, water treatment member replacement processing to remove another water treatment member having a life expectancy within a predetermined range from a life expectancy of the water treatment member that needs to be replaced from a second water treatment device that is different from the first water treatment device, mount the other water treatment member on the first water treatment device, and mount a new water treatment member on the second water treatment device.

The history information of the water treatment member that is mounted on the water treatment device is updated with an operation of the water treatment device, and the life expectancy estimation processing to estimate the life expectancy of each water treatment member is performed based on the history information. When need for replacement of the water treatment member in the first water treatment device arises, the water treatment member replacement processing to remove another water treatment member having the life expectancy within the predetermined range with respect to the life expectancy of the water treatment member that needs to be replaced from the second water treatment device that is different from the first water treatment device, mount the other water treatment member on the first water treatment device, and mount the new water treatment member on the second water treatment device is performed, whereby it is possible to collect similar water treatment members having short life expectancies in the first water treatment device and reduce frequency of occurrence of a failure in the second water treatment device on which the new water treatment member is mounted.

In addition to the above-mentioned first feature configuration, the replacement method for the water treatment member according to the present invention has a second feature configuration that the history information includes a manufacturing history and a usage history that are managed for each water treatment member, and the life expectancy estimation processing is to perform learning processing on previously acquired history information of a plurality of water treatment members until occurrence of a failure of each of the plurality of water treatment members to generate a life expectancy estimation model representing a relationship between individual history information and a life expectancy, and apply history information of an individual water treatment member to the life expectancy estimation model to estimate the life expectancy.

In addition to the above-mentioned first to second feature configurations, the replacement method for the water treatment member according to the present invention has a third feature configuration that the water treatment member is a membrane module, and the water treatment device is a membrane unit on which the membrane module is mounted.

As a first feature configuration of a life expectancy estimation method for a water treatment member according to the present invention, a life expectancy estimation method for a water treatment member that is mounted on a water treatment device includes managing history information including a manufacturing history and usage history of each water treatment member in association with water treatment member identification information that individually identifies each water treatment member, and performing learning processing on previously acquired history information of a plurality of water treatment members until occurrence of a failure to generate a life expectancy estimation model representing a relationship between the history information and a life expectancy and applying the history information of an individual water treatment member to the life expectancy estimation model to estimate the life expectancy.

Managing the history information of each water treatment member in association with the water treatment member identification information that individually identifies each water treatment member enables individual grasping of the history information including the manufacturing history and usage history of each water treatment member. The learning processing is performed on history information of a plurality of water treatment members in each of which a failure occurs, whereby a relationship between a lifetime from a manufacturing period to the occurrence of the failure and history information can be obtained, and the life expectancy estimation model indicating how much a life expectancy is left is generated with respect to freely-selected history information based on the relationship. The inclusion of the manufacturing history as the history information enables incorporation of the life expectancy depending on the manufacturing period into the life expectancy estimation model. The inclusion of the usage history enables incorporation of the life expectancy depending on a usage state, such as accumulated operating time and the number of cleanings, into the life expectancy estimation model. The history information of a water treatment member as an estimation target is applied to the generated life expectancy estimation model, whereby the life expectancy of the water treatment member as the estimation target is estimated.

In addition to the above-mentioned first feature configuration, the life expectancy estimation method for the water treatment member according to the present invention has a second feature configuration that the learning processing includes statistical processing.

The statistical processing can be preferably used as the learning processing. For example, a multivariate analysis method such as multiple regression analysis using each of the manufacturing history and the usage history as an explanatory variable and the life expectancy as an objective variable can be adopted.

### Advantageous Effects of Invention

As described above, the present invention enables provision of a management method for a water treatment device to manage the water treatment device so as to extend a lifetime of an individual water treatment member based on history information of the water treatment member, a replacement method for a water treatment member, and a life expectancy estimation method for the water treatment member.

### BRIEF DESCRIPTION OF DRAWINGS

FIG. 1A is a diagram for describing a membrane unit. FIG. 1B is a diagram for describing a membrane module.

FIG. 2 is a side surface view for describing the membrane unit.

FIG. 3A is a diagram for describing a suspension jig. FIG. 3B is a diagram for describing an engagement portion of the suspension jig.

FIGS. 4A and 4B are diagrams for describing how to use the suspension jig.

FIG. 5 is a diagram for describing a functional block of a history management system of the membrane module.

FIG. 6 is a diagram for describing external life expectancy homogenization processing.

FIG. 7 is a diagram for describing internal life expectancy homogenization processing.

FIG. 8 is a diagram for describing water treatment member replacement processing.

### MODE FOR CARRYING OUT THE INVENTION

The following description will be given of a management method for a water treatment device, a replacement method for a water treatment member, and a life expectancy estimation method for the water treatment member according to the present invention taking a membrane unit for example as an example of the water treatment device. A membrane module as the water treatment member is mounted on the membrane unit in a replaceable manner. The membrane unit is a device that is used for being submerged in a biological treatment tank, separating treated water subjected to biological treatment from activated sludge, and extracting the treated water.

### Configuration of Membrane Unit

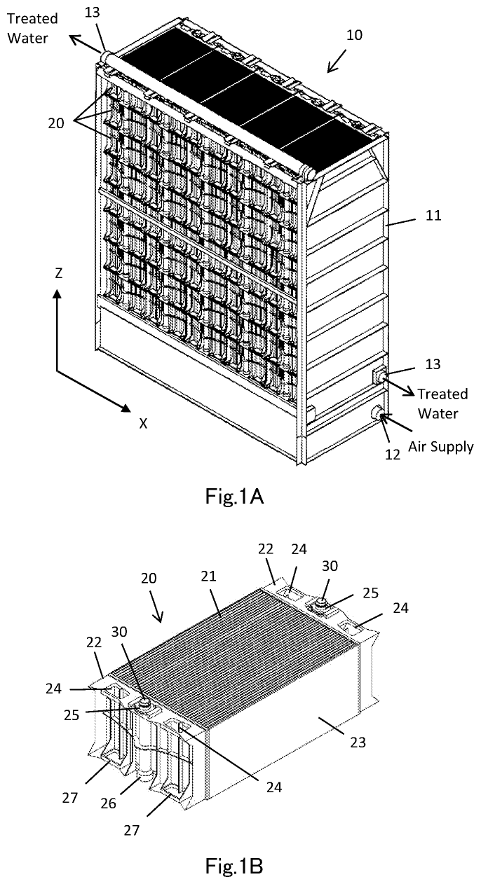

FIGS. 1A and 1B each exemplify an outer appearance of a membrane unit 10 and that of a membrane module 20 mounted on the membrane unit 10. The membrane unit 10 includes five rows of membrane module groups, in each of which membrane modules 20 are longitudinally arranged to form an eight-stage stack, and that are laterally arranged side by side in a frame body 11. The membrane unit 10 is submerged and disposed in a biological reaction tank to subject liquid to be treated in the biological reaction tank to membrane filtration with the membrane module 20 and extract treated water.

The membrane module 20 includes a pair of front and rear water collecting cases 22 that is arranged on respective end portions in a depth direction of a main body frame that constitutes the frame body 11, and is configured so that a plurality of membrane elements 21 in a longitudinal posture is arranged side by side in a horizontal direction in a space defined by a pair of side plates 23 disposed between the pair of front and rear water collecting cases 22.

Each membrane element 21 is composed of a filter plate in a form of a flat panel, where a filtration membrane is disposed on each side of the filer plate, and is configured so that treated water that has permeated through the filtration membrane is led to the inside of each water collecting case 22 through a water collecting channel formed in the filter plate. The filter plate is formed of an acrylonitrile-butadiene-styrene (ABS) resin or the like, and the filtration membrane is formed by impregnating a porous resin into a non-woven fabric as a base material. The water collecting case 22 is made of polypropylene or the like, and formed to have translucency so that the inside of the water collecting case 22 is easily checked.

Each water collecting case 22 is formed in a hollow shape having a water collecting space inside, and has coupling portions 25 and 26 that communicate with the water collecting space on upper and lower surfaces of the water collecting case 22, respectively. The upper coupling portion 25 is configured so that a coupling member 30 to be impacted into the lower coupling portion 26 formed in the water collecting case 22 of the membrane module 20 stacked immediately above is attached to the upper coupling portion 25.

Engagement holes 24 as a pair of left and right engaged potions are formed on the upper and lower surfaces of the water collecting case 22, respectively. The upper and lower engagement holes 24 are formed so as to be in contact with corresponding engagement holes 24 of membrane modules 20 that are longitudinally adjacent thereto when the membrane modules 20 are disposed and formed as a stack, and are configured so that respective engagement portions 42 of a suspension jig 40 penetrate through the upper and lower engagement holes 24 in a state where the engagement holes 24 of the longitudinally adjacent membrane modules 20 are in contact therewith and the upper and lower engagement holes 24 can be engaged with the engagement holes 24 of the longitudinally adjacent membrane modules 20. An edge portion of each engagement hole 24 functions as a handle 27 for an operator to grasp the membrane module.

A diffuser air supply pipe 12 is disposed under a membrane module 20 in the bottom stage, and diffusion air supplied by the diffuser air supply pipe 12 generates cross-flow of the liquid to be treated in the biological reaction tank between the plurality of membrane elements 21 arranged side by side in a horizontal direction in the longitudinal posture in each membrane module 20. Permeated water that has permeated through a membrane surface of each membrane element 21 is guided to the outside of the tank via a water collecting pipe 13.

The water collecting pipe 13 communicates with a permeated water outlet pipe (not illustrated) that leads to a treated water tank disposed outside the biological treatment tank, and a pumping device is disposed on a path of a pipeline of the permeated water outlet pipe. The diffuser air supply pipe 12 communicates with an air supply source such as a blower and a compressor.

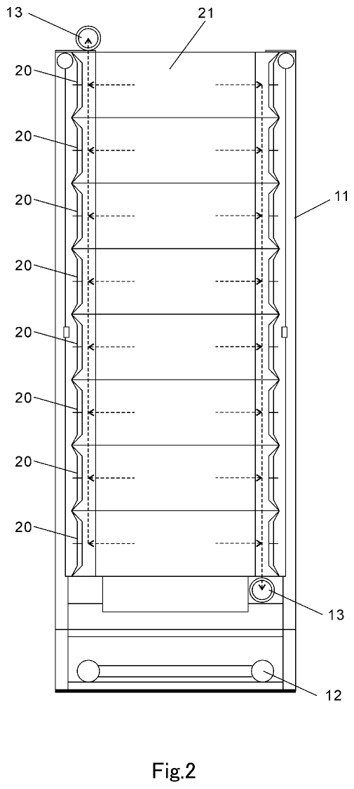

As illustrated in FIG. 2, the water collecting pipe 13 is coupled to each of the upper coupling portion 25 (refer to FIG. 1B) of a membrane module 20 in the top stage on the left side and the lower coupling portion 26 (refer to FIG. 1B) of the membrane module 20 in the bottom stage on the right side. The lower coupling portion 26 of the membrane module 20 on the left side in the bottom stage and the upper coupling portion 25 of the membrane module 20 on the right side in the top stage are sealed with a sealing member. Note that in FIG. 2, illustration of the upper coupling portion 25 and the lower coupling portion 26 is omitted, and a flow direction of the permeated water is indicated by a broken line.

Note that in this example, five rows of membrane module groups, in each of which the membrane modules 20 are longitudinally arranged to form an eight-stage stack, are laterally arranged side by side, but the number of stages and the number of rows can be set as appropriate. For example, the membrane unit 10 can be configured to have five rows of membrane module groups, in each of which the membrane modules 20 are longitudinally arranged to form a twelve-stage stack, are laterally arranged side by side, or five rows of membrane module groups, in each of which the membrane modules 20 are longitudinally arranged to form a sixteen-stage stack, are laterally arranged side by side. Arranging a plurality of such membrane units 10 enables structuring of large-scale water treatment equipment.

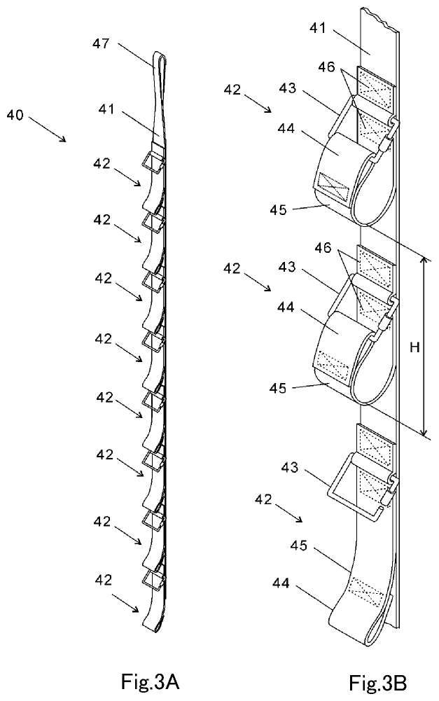

FIGS. 3A and 3B each exemplify the suspension jig 40 for lifting upward the membrane modules 20 that are longitudinally disposed and formed as a stack. The suspension jig 40 includes a long base member 41 and a plurality of engagement portions 42 that is engageable/removable with/from the respective engagement holes 24 arranged in each of the membrane modules 20 that are disposed to form a multiple-stage stack. In the present embodiment, the base member 41 is provided with eight engagement portions 42. The number of engagement portions 42 is identical to the number of stages of the stack of the membrane modules 20 in the main body frame of the membrane unit 10. A ring-shaped portion 47 is formed at an upper end of the base member 41, and the suspension jig 40 is used in a state where the ring-shaped portion 47 is engaged with a hook or the like.

The engagement portion 42 is composed of an engagement ring 43 and a sling piece 45. At one end of the sling piece 45, a ring portion 44 that is impacted into the engagement ring 43 is formed. The other end of the sling piece 45 is attached by sewing to the base member 41. The engagement ring 43 is fixed to a sewn portion 46 of the sling piece 45. The sewn portion 46 is sewn to the base member 41.

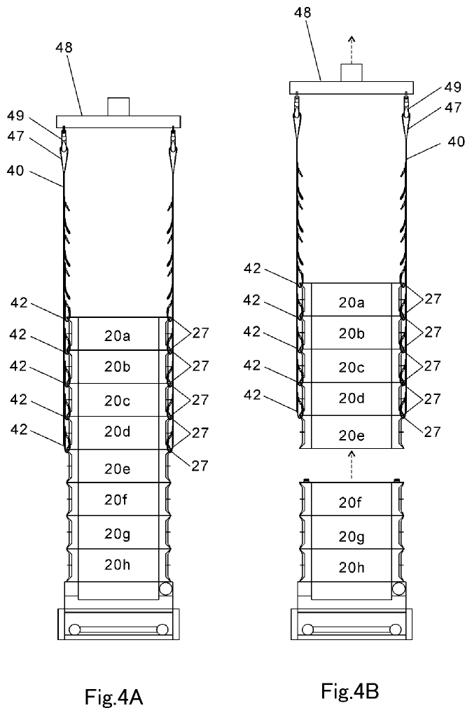

FIGS. 4A and 4B each illustrate part of procedures for replacing a membrane module in a specific stage using the above-mentioned suspension jig 40. In a case where a membrane module 20e that is stacked in the fifth stage from the top of the eight-stage stack of a membrane module (20a to 20h) group is to be replaced, the engagement portions 42 of the suspension jig 40 are first engaged with the respective engagement holes 24 of each membrane module from the membrane module 20a in the top stage to the membrane module 20e in the specific stage on both sides of the membrane module group.

A suspension beam 48 that is suspended by a crane is provided with four hooks 49, with each of which the suspension jig 40 is engaged, so as to be capable of lifting the membrane modules 20 from four corners.

The suspension beam 48 with which four suspension jigs 40 are engaged are lifted upward, whereby the membrane modules from the membrane module 20a in the top stage to the membrane module 20e in the specific stage are separated from the remaining membrane modules 20f, 20g, and 20h.

Thereafter, the membrane modules 20a to 20e are placed on a base, and the membrane module 20e is replaced with a new membrane module. Thereafter, the suspension beam 48 is lifted upward, moved above the membrane modules 20f, 20g, and 20h, and lowered, whereby an operation of replacing the membrane module 20e ends. Note that a specific configuration of the suspension jig 40 is not limited to the above-mentioned mode that requires the operator to perform an operation of wrapping the suspension jig 40 around the membrane modules 20. The suspension jig 40 may have a configuration of including an engagement portion that allows a machine such as a robot to automatically hook the membrane modules 20 without the need for the operation by the operator. With such a configuration, a mechanical device capable of automatically performing replacement processing may be used.

### History Management for Membrane Module

In an operational state in which permeated water is extracted with the membrane unit 10 that is submerged and disposed in the biological treatment tank, a membrane filtration state in which a pump is driven for extraction of the permeated water and a refresh state in which the extraction of the permeated water is stopped and only air diffusion is performed for cleaning of a membrane surface are repeated at predetermined intervals. When membrane clogging of the membrane module 20 becomes severe due to long-hours of operation, cleaning liquid is supplied from the water collecting pipe 13 and reverse cleaning is performed, whereby membrane performance is recovered.

The lifetime of the membrane module 20 is very long, as long as ten years, but there is a possibility that filtration performance decreases or the membrane module 20 is broken as accumulated operation time becomes longer, and a degree of deterioration is also different depending on at which position of the frame body 11 of the membrane unit 10 the membrane module 20 is mounted. For example, a load applied to a membrane module 20 mounted on a lower portion of the frame body 11 is significantly affected by foreign substances floating in the tank, and thus tends to be higher than a load applied to a membrane module 20 mounted on an upper portion of the frame body 11.

Hence, it is important to grasp a life expectancy of each membrane module 20 by managing a history of each membrane module 20 from its manufacturing time to its latest usage time. Additionally, frequent occurrence of the operation of replacing the membrane module 20 in each of a plurality of membrane units 10 not only makes maintenance work significantly cumbersome but also may possibly hinder a stable operation. To address this, a history management system for the membrane module 20 is structured.

### History Management System for Membrane Module

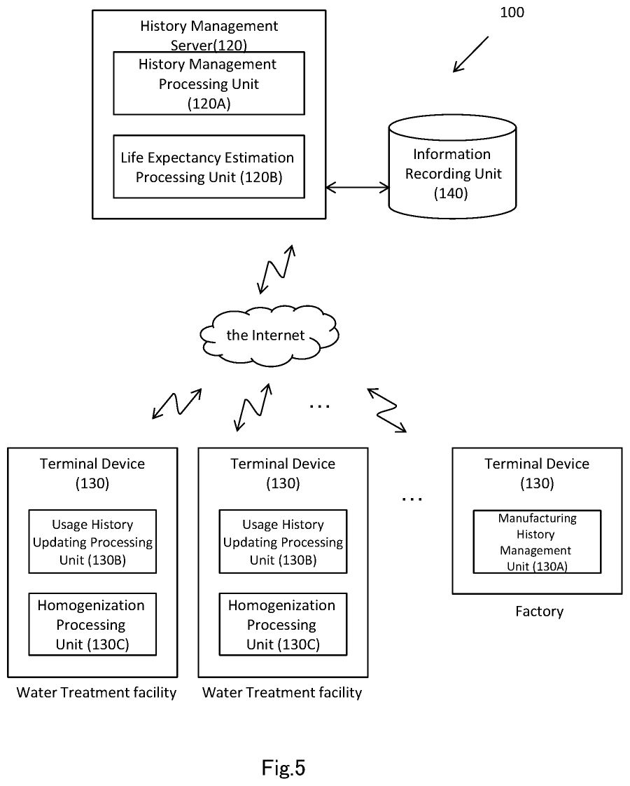

As illustrated in FIG. 5, a history management system 100 for a membrane module includes a history management server 120 and a plurality of terminal devices 130 capable of communicating with the history management server 120 via the Internet. The terminal device 130 is installed in each water treatment facility in which a plurality of membrane units 10 or a single membrane unit 10 is disposed, and is disposed in a manufacturing factory for the membrane modules 20.

The history management server 120 includes a history management processing unit 120A that manages history information of each membrane module 20 transmitted from the terminal device 130 and a life expectancy estimation processing unit 120B that estimates the life expectancy of each membrane module 20. Each of the history information of each membrane module 20 subjected to processing in the history management processing unit 120A and the life expectancy of each membrane module 20 estimated by the life expectancy estimation processing unit 120B is output to an information recording unit 140 serving as a database system connected to the history management server 120, and centrally managed in the information recording unit 140.

The terminal device 130 disposed in the manufacturing factory includes a manufacturing history management unit 130A, and the terminal device 130 disposed in the water treatment facility includes a usage history updating processing unit 130B and a homogenization processing unit 130C.

The history information of the membrane module 20 managed by the history management system 100 includes a manufacturing history generated in the manufacturing history management unit 130A and a usage history generated in the usage history updating processing unit 130B.

The manufacturing history includes a manufacturing lot management number and a manufacturing management number. The manufacturing lot management number identifies a manufacturing factory and a manufacturing period. The manufacturing management number uniquely identifies an individual membrane module and allows for management of a detailed manufacturing date. The manufacturing management number serves as membrane module identification information that enables individual identification of each membrane module 20.

The usage history is a history managed in association with the membrane module identification information, and includes membrane unit identification information, membrane unit address information, a usage start period, accumulated usage time, a chemical cleaning history, and a failure history.

The membrane unit identification information is information that individually identifies the membrane unit 10 on which the membrane module 20 is mounted, and the membrane unit address information is information indicating a mounting position of the membrane module 20 in the membrane unit 10.

The usage start period is information indicating the usage start period of the membrane module 20. The accumulated usage time is accumulated time for using the membrane module 20 for membrane filtration. The chemical cleaning history is information indicating a chemical cleaning period and a chemical concentration. The failure history is information indicating an occurrence period of membrane clogging, membrane rupture, or the like.

The usage start period, the accumulated usage time, the chemical cleaning history, and the failure history are managed in association with an information pair of the membrane unit identification information and the membrane unit address information. That is, the usage start period, the accumulated usage time, the chemical cleaning history, and the failure history are managed for each mounting position in the membrane unit.

The manufacturing history generated in the manufacturing history management unit 130A is transmitted to the history management processing unit 120A of the history management server 120, and a history management record for the individual membrane module 20 is generated and stored in the information recording unit 140.

The usage history generated in the usage history updating processing unit 130B is transmitted to the history management processing unit 120A, for example, at a frequency of once a day, and a history information field that is set to the history management record for the individual membrane module 20 stored in the information recording unit 140 is updated.

A transmission frequency of the usage history is not limited to the frequency of once a day, and may be a frequency of once in every several hours, or a frequency of once in every twelve hours. The usage history may be transmitted at a timing when an event of some kind occurs in the membrane unit 10. The event of some kind may be, for example, a stop period of the membrane unit 10, an operation start period, a cleaning period of the membrane module 20, and a failure occurrence period of the membrane module 20. The history management system 100 is only required to be configured to transmit the history accumulated by then in the usage history updating processing unit 130B to the history management processing unit 120A at this point.

The history management system 100 may be configured to automatically input the usage history accumulated in the usage history updating processing unit 130B from a control device that controls the water treatment facility, or an operator who manages the water treatment facility may manually input the usage history.

The life expectancy estimation processing unit 120B included in the history management server 120 is stored in the information recording unit 140, and estimates the life expectancy of each membrane module 20 based on the history information of each membrane module 20. The history information is up datable as needed. Specifically, the life expectancy estimation processing unit 120B performs learning processing on previously acquired history information of a plurality of membrane modules 20 until occurrence of a failure to generate a life expectancy estimation model representing a relationship between individual history information and a life expectancy, and applies the history information of an individual water treatment member to the life expectancy estimation model to estimate the life expectancy.

Statistical processing such as a multivariate analysis method can be preferably used as the learning processing. For example, the life expectancy estimation processing unit 120B performs multiple regression analysis using each field information of the manufacturing history and the usage history as an explanatory variable and using the life expectancy as an objective variable, and can thereby generate a model formula by which the life expectancy is calculated based on the manufacturing history and the usage history. As the field information, the manufacturing period, the mounting position in the membrane unit, the accumulated usage time, and the number of chemical cleanings can be mainly used.

The field information managed as the usage history is not limited to the above-mentioned items, and can additionally include a duration of contact with cleaning chemicals, composted sewage sludge (CSS) (substance remaining on a sieve having an aperture of about 1 mm), mixed liquor suspended solid (MLSS), an amount of diffused air supplied via an air diffuser, and the like, and these can also be adopted as explanatory variables.

Alternatively, the history management system 100 may be configured to perform leaning using artificial intelligence (AT) based on the history information stored in the information recording unit 140 to generate a model formula with which the life expectancy is calculated. For example, in a treatment facility with frequent occurrence of a result that is different from the life expectancy derived from a result of the multiple regression analysis obtained from data at multitudes of treatment sites, the AT determines that there is another element that affects the life expectancy, and can generate a new model formula that is unique to the treatment site.

The life expectancy estimation processing is executed by the life expectancy estimation processing unit 120B in a predetermined period when the climate is mild and a processing amount of water to be treated is stable such as before a rainy season and accumulation of snow, and a result thereof is recorded in the information recording unit 140 and transmitted to the terminal device 130 in each water treatment facility. Setting the predetermined period before the rainy season is to appropriately take measures before a water treatment amount increases due to rainfall. Setting the predetermined period before accumulation of snow is to appropriately take measures before a water treatment load increases due to decreased water treatment capacity by activated sludge in a winter season. Note that the predetermined period mentioned herein is not intended to be limited to these periods, and can be set as appropriate as need arises.

The terminal device 130, in each water treatment facility, which has obtained the life expectancy of each membrane module 20 estimated by the life expectancy estimation processing causes the homogenization processing unit 130C to execute lifetime homogenization processing on each membrane module 20 in the water treatment facility.

### First Embodiment of Homogenization Processing

The homogenization processing unit 130C executes external life expectancy homogenization processing to replace corresponding water treatment members with each other among a plurality of water treatment devices at a predetermined period so that other membrane modules 20 each having a life expectancy within a predetermined range with respect to the life expectancy of each membrane module 20 estimated by the life expectancy estimation processing are mounted in an identical membrane unit 10.

The homogenization processing unit 130C performs the external life expectancy estimation processing at the predetermined period to remove membrane modules 20 each having a life expectancy within the predetermined range from the estimated life expectancy of each membrane module 20 from other membrane units 10, that is, external membrane units 10 so that the membrane modules 20 each having the life expectancy within the predetermined range from the estimated life expectancy of each membrane module 20 are mounted in the identical membrane unit 10, and can thereby reconstruct the membrane units 10 into a membrane unit 10 on which a plurality of membrane modules 20 each having a relatively short life expectancy are mounted, a membrane unit 10 on which membrane modules 20 each having a long life expectancy are mounted, and the like. As a result, even if a failure occurs in the membrane unit 10 on which a plurality of water treatment members each having a relatively short life expectancy is mounted, it is possible to reduce a frequency of occurrence of the failure in other membrane units 10, and increase an operating rate of the membrane units 10 as a whole.

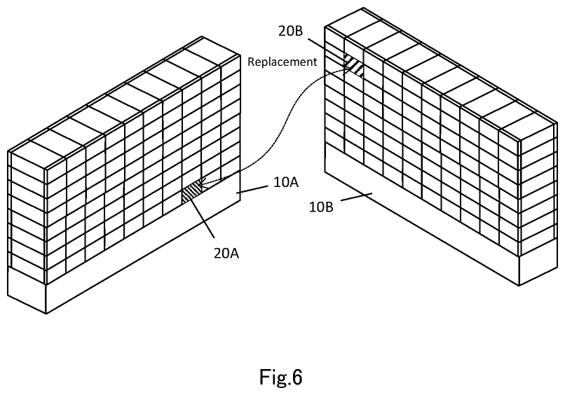

As illustrated in FIG. 6, for example, in a case where a life expectancy of a membrane module 20A mounted on a membrane unit 10A is significantly different from life expectancies of other membrane modules mounted on the membrane unit 10A, a membrane module 20B having a life expectancy within the predetermined range from the life expectancies of the other modules mounted on the membrane unit 10A is removed from a membrane unit 10B and mounted on the membrane unit 10A. The membrane module 20A is mounted on another membrane unit 10B on which many membrane modules each having a life expectancy within the predetermined range with respect to the life expectancy of the membrane module 20A are mounted.

This is an extreme example. Typically, membrane modules are grouped based on life expectancies of all the membrane modules mounted on each membrane unit, and the grouped membrane modules are mounted on an identical membrane unit. The predetermined range is only required to be a numeric value within a range in which life expectancies can be handled as being almost equal, and is not specifically limited.

### Second Embodiment of Homogenization Processing

The homogenization processing unit 130C performs, based on the life expectancy of each membrane module 20 estimated in the life expectancy estimation processing, internal life expectancy homogenization processing to mount, at a predetermined period, a membrane module 20 having a relatively long life expectancy at a high-processing load position in an identical membrane unit 10 and a membrane module 20 having a relatively short life expectancy at a low-processing load position in the identical membrane unit 10.

The homogenization processing unit 130C performs, based on the estimated life expectancy of each membrane module 20, the internal life expectancy homogenization processing at the predetermined period to mount the membrane module 20 having the relatively long life expectancy at the high-processing load position in the identical membrane unit 10, and mount the membrane module 20 having the relatively short life expectancy at the low-processing load position in the identical membrane unit 10, and can thereby extend a life expectancy of a water treatment member having a short life expectancy, avoid occurrence of the failure as much as possible, and increase an operating rate of the water treatment device.

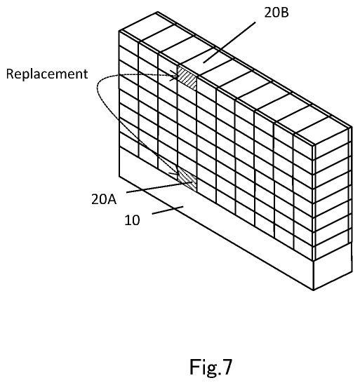

As illustrated in FIG. 7, for example, the life expectancy of the membrane module 20A mounted at the high-processing load position among the membrane unit 10 and the life expectancy of the membrane module 20B mounted at the low-processing load position among the identical membrane unit 10 are compared with each other. In a case where the life expectancy of the membrane module 20B is sufficiently longer than the life expectancy of the membrane module 20A, mounting positions thereof are replaced with each other.

For example, based on the life expectancies of all the membrane modules 20 mounted on the membrane unit 10, the membrane modules 20 are grouped into eight groups in units of ten membrane modules 20 in the descending order of the life expectancies, and a group of the longest life expectancy is mounted on the bottom stage, and the remaining groups can be subsequently mounted in the descending order of the life expectancies from the lower stage to the upper stage.

In a case where a process load is different depending on an array position even in the identical stage of the membrane unit 10, the membrane modules 20 each having a long expectancy can be mounted in the descending order of processing loads.

### Other Embodiments

When the above-mentioned external life expectancy homogenization processing is executed, the internal life expectancy homogenization processing may be executed together.

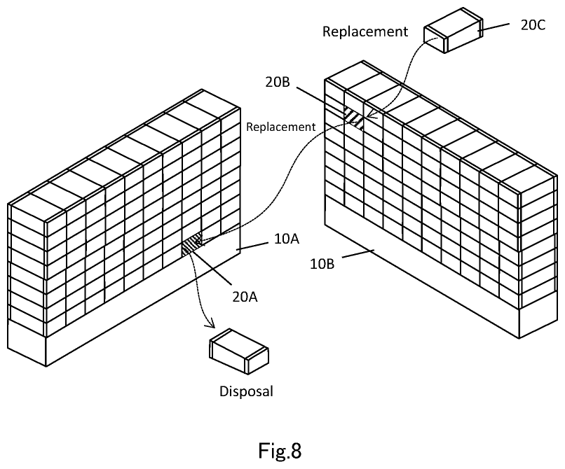

As illustrated in FIG. 8, in a case where a failure occurs in one membrane unit 10A and the membrane module 20A needs to be replaced, the homogenization processing unit 130C may be configured to execute membrane module replacement processing to remove another membrane module 20B having a life expectancy within a predetermined range from a life expectancy of the membrane module 20A that needs to be replaced, which is estimated in the life expectancy estimation processing, from the membrane unit 10B that is different from the membrane unit 10A, mount the membrane module 20B on the membrane unit 10A, and mount a new membrane module 20C on the other membrane unit 10B.

Such membrane module replacement processing enables collection of the membrane module 20B having the life expectancy that is equivalent to the life expectancy of the membrane module 20A in one membrane unit 10A, and enables reduction in frequency of occurrence of the failure in the other membrane unit 10B on which the new membrane module is mounted. Note that also in this case, the predetermined range is only required to be a numeric value within a range in which life expectancies can be handled as being almost equal, and is not specifically limited.

As described above, the life expectancy estimation processing according to the present invention is to manage the history information including the manufacturing history and usage history of each membrane module in association with the module identification information that individually identifies each membrane module, perform the learning processing on the previously acquired history information of the plurality of membrane modules until occurrence of the failure to generate the life expectancy estimation model representing the relationship between the history information and the life expectancy, and apply the history information of the individual module to the life expectancy estimation model to estimate the life expectancy.

While the above description has been given of the history management method and the history management system for the membrane module serving as the water treatment member taking the membrane unit for example as one example of the water treatment device, the water treatment member is not limited to the membrane module, and the history management method and the history management system can be applied to a water treatment member such as a plurality of activated carbon cartridges mounted on an activated carbon unit.

That is, a history management method for a water treatment member according to the present invention serving as a management method for water treatment equipment provided with a plurality of water treatment devices on each of which a plurality of water treatment members is mounted includes performing life expectancy estimation processing to estimate a life expectancy of each water treatment member based on history information of each water treatment member, the history information being up datable as needed, and performing external life expectancy homogenization processing to replace corresponding water treatment members with each other among a plurality of water treatment devices at a predetermined period so that other water treatment members each having a life expectancy within a predetermined range with respect to the life expectancy of each water treatment member estimated in the life expectancy estimation processing are mounted in an identical water treatment device.

Additionally, a management method for water treatment equipment provided with a water treatment device on which a plurality of water treatment members is mounted includes performing life expectancy estimation processing to estimate a life expectancy of each water treatment member based on history information of each water treatment member, the history information being updatable as needed, and performing, based on the life expectancy of each water treatment member estimated in the life expectancy estimation processing, internal life expectancy homogenization processing to mount, at a predetermined period, a water treatment member having a relatively long life expectancy at a high-processing load position in an identical water treatment device and a water treatment member having a relatively short life expectancy at a low-processing load position in the identical membrane processing.

That is, a replacement method for a water treatment member according to the present invention serving as a replacement method for a water treatment member that is mounted on each of a plurality of water treatment devices includes performing life expectancy estimation processing to estimate a life expectancy of each water treatment member based on history information of each water treatment member, the history information being updatable as needed, and performing, when need for replacement of a water treatment member in a first water treatment device arises, water treatment member replacement processing to remove another water treatment member having a life expectancy within a predetermined range from a life expectancy of the water treatment member that needs to be replaced from a second water treatment device that is different from the first water treatment device, mount the other water treatment member on the first water treatment device, and mount a new water treatment member on the second water treatment device.

The history information includes a manufacturing history and a usage history that are managed for each water treatment member. The life expectancy estimation processing is to perform learning processing on previously acquired history information of a plurality of membrane modules until occurrence of a failure to generate a life expectancy estimation model representing a relationship between individual history information and a life expectancy, and apply history information of an individual water treatment member to the life expectancy estimation model to estimate the life expectancy.

A life expectancy estimation method for a water treatment member according to the present invention serving as a life expectancy estimation method for a water treatment member that is mounted on a water treatment device includes managing history information including a manufacturing history and usage history of each water treatment member in association with water treatment member identification information that individually identifies each water treatment member, and performing learning processing on previously acquired history information of a plurality of water treatment members until occurrence of a failure to generate a life expectancy estimation model representing a relationship between the history information and a life expectancy and applying the history information of an individual water treatment member to the life expectancy estimation model to estimate the life expectancy.

The above-mentioned embodiments are merely examples of the present invention, the scope of the present invention is not limited by the description, and a specific configuration of each component can be modified in design as appropriate within a range that provides actions and effects of the present invention.

### REFERENCE SIGNS LIST

10 Water treatment device (membrane unit)

20 Water treatment member (membrane module)

100 History management system

120 History management server

120A History management processing unit

120B Life expectancy estimation processing unit

130 Terminal device

130A Manufacturing history management unit

130B Usage history updating processing unit

130C Homogenization processing unit

140 Information recording unit

1. A management method for a water treatment device that serves as a management method for water treatment equipment provided with a plurality of water treatment devices on each of which a plurality of water treatment members is mounted, the method comprising:
performing life expectancy estimation processing to estimate a life expectancy of each water treatment member based on history information of each water treatment member, the history information being updatable as needed; and
performing external life expectancy homogenization processing to replace corresponding water treatment members with each other among a plurality of water treatment devices at a predetermined period so that other water treatment members each having a life expectancy within a predetermined range with respect to the life expectancy of each water treatment member estimated in the life expectancy estimation processing are mounted in an identical water treatment device.

2. A management method for water treatment equipment that serves as a management method for water treatment equipment provided with a water treatment device on which a plurality of water treatment members is mounted, the method comprising:
performing life expectancy estimation processing to estimate a life expectancy of each water treatment member based on history information of each water treatment member, the history information being updatable as needed; and
performing, based on the life expectancy of each water treatment member estimated in the life expectancy estimation processing, internal life expectancy homogenization processing to mount, at a predetermined period, a water treatment member having a relatively long life expectancy at a high-processing load position in an identical water treatment device and a water treatment member having a relatively short life expectancy at a low-processing load position in the identical water treatment device.

3. The management method for the water treatment equipment according to claim 1, wherein
the history information includes a manufacturing history and a usage history that are managed for each water treatment member, and
the life expectancy estimation processing is to perform learning processing on previously acquired history information of a plurality of water treatment members until occurrence of a failure to generate a life expectancy estimation model representing a relationship between individual history information and a life expectancy, and apply history information of an individual water treatment member to the life expectancy estimation model to estimate the life expectancy.

4. The management method for the water treatment equipment according to claim 1, wherein the water treatment member is a membrane module, and the water treatment device is a membrane unit on which the membrane module is mounted.

5. A replacement method for a water treatment member that serves as a replacement method for a water treatment member that is mounted on each of a plurality of water treatment devices, the method comprising:
performing life expectancy estimation processing to estimate a life expectancy of each water treatment member based on history information of each water treatment member, the history information being updatable as needed; and
performing, when need for replacement of a water treatment member in a first water treatment device arises, water treatment member replacement processing to remove another water treatment member having a life expectancy within a predetermined range from a life expectancy of the water treatment member that needs to be replaced from a second water treatment device that is different from the first water treatment device, mount the another water treatment member on the first water treatment device, and mount a new water treatment member on the second water treatment device.

6. The replacement method for the water treatment member according to claim 5, wherein
the history information includes a manufacturing history and a usage history that are managed for each water treatment member, and
the life expectancy estimation processing is to perform learning processing on previously acquired history information of a plurality of water treatment members until occurrence of a failure to generate a life expectancy estimation model representing a relationship between individual history information and a life expectancy, and apply history information of an individual water treatment member to the life expectancy estimation model to estimate the life expectancy.

7. The replacement method for the water treatment member according to claim 5, wherein the water treatment member is a membrane module, and each water treatment device is a membrane unit on which the membrane module is mounted.

8. A life expectancy estimation method for a water treatment member that serves as a life expectancy estimation method for a water treatment member that is mounted on a water treatment device, the method comprising:
managing history information including a manufacturing history and usage history of each water treatment member in association with water treatment member identification information that individually identifies each water treatment member; and
performing learning processing on previously acquired history information of a plurality of water treatment members until occurrence of a failure to generate a life expectancy estimation model representing a relationship between the history information and a life expectancy, and applying the history information of an individual water treatment member to the life expectancy estimation model to estimate the life expectancy.

9. The life expectancy estimation method for the water treatment member according to claim 8, wherein the learning processing includes statistical processing.

10. The management method for the water treatment equipment according to claim 2, wherein
the history information includes a manufacturing history and a usage history that are managed for each water treatment member, and
the life expectancy estimation processing is to perform learning processing on previously acquired history information of a plurality of water treatment members until occurrence of a failure to generate a life expectancy estimation model representing a relationship between individual history information and a life expectancy, and apply history information of an individual water treatment member to the life expectancy estimation model to estimate the life expectancy.

11. The management method for the water treatment equipment according to claim 2, wherein the water treatment member is a membrane module, and the water treatment device is a membrane unit on which the membrane module is mounted.

12. The replacement method for the water treatment member according to claim 6, wherein the water treatment member is a membrane module, and each water treatment device is a membrane unit on which the membrane module is mounted.
